(19) United States
(12) Patent Application Publication
(10) Pub. No.: US 2012/0263390 A1
(43) Pub. Date: Oct. 18, 2012

(54) DECODING A QUILTED GRAPHIC 2D IMAGE REPRESENTATION INTO A DIGITAL ASSET

(76) Inventor: Jorg-Ulrich Mohnen, West Hollywood, CA (US)

(21) Appl. No.: 13/443,759

(22) Filed: Apr. 10, 2012

Related U.S. Application Data
(60) Provisional application No. 61/517,057, filed on Apr. 12, 2011.

(51) Int. Cl. G06K 9/36

(52) U.S. Cl. 382/233

(57) ABSTRACT

The present invention extends to methods, systems, and computer program products for decoding a quilted graphic 2D image representation into a digital asset. Portions of a digital asset (e.g., audio data, video data, geospatial data, etc.) are encoded as series of graphical representations and quilted into a quilted graphic 2D image representation. Encoding takes redundancies and multiple levels of resolution within successive graphic image representations into account, reducing (potentially substantially) resource consumption when storing and transmitting digital assets. The quilted graphic 2D image representation can be unquilted and decoded to recreate digital asset portions. Decoding can take the redundancies into account to recreate full representations (or representations at lower resolutions) of digital assets from the encoded graphical representations quilted into the quilted graphic 2D image representation.

### CROSS-REFERENCE TO RELATED APPLICATIONS

This application claims the benefit of U.S. Provisional Patent Application No. 61/517,057, entitled “Spatial and Temporal Block by Block Streaming of 16-bit Sound as an Image”, filed Apr. 12, 2011, which is incorporated herein in its entirety.

### BACKGROUND

### Background and Relevant Art

Computer systems and related technology affect many aspects of society. Indeed, the computer system's ability to process information has transformed the way we live, work, and interact. Computer systems now commonly perform a host of tasks (e.g., word processing, scheduling, accounting, communicating, etc.) that prior to the advent of the computer system were performed manually. More recently, computer systems have been coupled to one another and to other electronic devices to form both wired and wireless computer networks over which the computer systems and other electronic devices can transfer electronic data. Accordingly, the performance of many computing tasks is distributed across a number of different computer systems and/or a number of different computing environments.

In some computing environments, transfer of data between computer systems includes one computer system downloading digital assets (e.g., a file, song, movie, data set, etc) from another computer system. In these computing environments, the downloading computer system can utilize the digital assets locally after downloading (e.g., opening a file, playing a song, etc). In other computing environments, transfer of data between computer systems includes sending computer system streaming digital assets to a receiving computer system. In these other computing environments, the receiving computer system can utilize or interact with portions of digital assets as they are received (e.g., playing a portion of a movie or song). In further computing environments, material is encoded on a local hard drive for greater storage efficiency.

In these and other computing environments, the transferred digital assets consume size computing resources (reflected, for example, in storage space, RAM, network bandwidth, etc.). In general, the larger the digital asset the more computing resources are consumed for storage and transfer of the digital asset. As such, various mechanisms find themselves employed to facilitate more efficient use of computing resources. For example, various transformation and data compression algorithms can be used to reduce digital asset sizes.

Lossy and lossless compression methods can be used. Lossy compression algorithms provide greater compression rates at the cost of losing some amount of a digital asset during compression. In some environments, lossy compression is preferred, such as, for example, when some loss of a digital asset is acceptable or perhaps is even imperceptible to a user (e.g., song quality may be degraded but the degradation is mostly imperceptible to the human ear or as afforded via the method of playback). Lossless compression algorithms provide lesser compression rates. However, there is limited, if any, loss of a digital asset during lossless compression.

### BRIEF SUMMARY

The present invention extends to methods, systems, and computer program products for decoding a quilted graphic 2D image representation into a digital asset. Embodiments of the invention include staging a quilted graphic 2D image representation. The quilted graphic 2D image representation contains one or more series of graphic representations quilted together to represent the content of one or more digital assets. The one or more series of graphic representations are contained within one or more rows and one or more columns of the quilted graphic 2D image representation.

Each of the one or more series of encoded graphic representations corresponds to a portion of one or more digital assets. Each of the one or more series of graphic representations having been encoded into the quilted graphic 2D image representation taking into account redundancies within the series of graphic representations. Conversion properties used to encode the quilted graphic 2D image representation are deduced for the quilted graphic 2D dimensional image. The conversion properties include a decoding order for decoding the one or more encoded digital assets.

The one or more rows and one or more columns of the quilted graphic 2D image representation are unquilted into the one or more digital assets. For each of the one or more series of graphic representations in accordance with the decoding order unquilting includes, identifying the redundancies between successive graphic representations within the series of graphic representations of a row and column within the two dimensional image. For each of the one or more series of graphic representations in accordance with the decoding order, unquilting includes decoding the series of graphic representations from the row and column taking into account the identified redundancies. Decoding can also be performed for one or more levels of resolution contained in the quilted graphic 2D image representation so as to decode the quilted graphic 2D image into a readable or playable state. For each of the one or more series of graphic representations in accordance with the decoding order, unquilting includes converting the decoded series of graphic representations into a corresponding portion of the one or more digital assets in accordance with the deduced conversion properties.

Subsequent to converting the decoded series of graphic representations into a corresponding portion of the one or more digital assets and when appropriate, the corresponding portion of the one or more digital assets can be rendered in one or more levels of resolution embedded in the quilted graphic 2D image representation.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an example computer architecture that facilitates decoding a quilted graphic 2D image representation into a digital asset.

FIG. 2 illustrates a flow chart of an example method for decoding a quilted graphic 2D image representation into a digital asset.

### DETAILED DESCRIPTION

The present invention extends to methods, systems, and computer program products for decoding a quilted graphic 2D image representation into a digital asset. Embodiments of the invention include staging a quilted graphic 2D image representation. The quilted graphic 2D image representation contains one or more series of graphic representations quilted together to represent the content of one or more digital assets. The one or more series of graphic representations are contained within one or more rows and one or more columns of the quilted graphic 2D image representation.

Each of the one or more series of encoded graphic representations corresponds to a portion of one or more digital assets. Each of the one or more series of graphic representations having been encoded into the quilted graphic 2D image representation taking into account redundancies within the series of graphic representations. Conversion properties used to encode the quilted graphic 2D image representation are deduced for the quilted graphic 2D dimensional image. The conversion properties include a decoding order for decoding the one or more encoded digital assets.

The one or more rows and one or more columns of the quilted graphic 2D image representation are unquilted into the one or more digital assets. For each of the one or more series of graphic representations in accordance with the decoding order, unquilting includes identifying the redundancies between successive graphic representations within the series of graphic representations of a row and column within the two dimensional image. For each of the one or more series of graphic representations in accordance with the decoding order, unquilting includes decoding the series of graphic representations from the row and column taking into account the identified redundancies. Decoding can also be performed for one or more levels of resolution contained in the quilted graphic 2D image representation so as to decode the quilted graphic 2D image into a readable or playable state. For each of the one or more series of graphic representations in accordance with the decoding order, unquilting includes converting the decoded series of graphic representations into a corresponding portion of the one or more digital assets in accordance with the deduced conversion properties

Subsequent to converting the decoded series of graphic representations into a corresponding portion of the one or more digital assets and when appropriate, the corresponding portion of the one or more digital assets can be rendered in one or more levels of resolution embedded in the quilted graphic 2D image representation.

Embodiments of the present invention may comprise or utilize a special purpose or general-purpose computer including computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, embodiments of the invention can comprise at least two distinctly different kinds of computer-readable media: computer storage media (devices) and transmission media.

Computer storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. RAM can also include solid state drives (SSDs or PCIx based real time

Storage such as FusionIO). Thus, it should be understood that computer storage media (devices) can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. Any of these computer system configurations can have a local drive to access encoded data stored thereon. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the invention can also be implemented in cloud computing environments. In this description and the following claims, “cloud computing” is defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

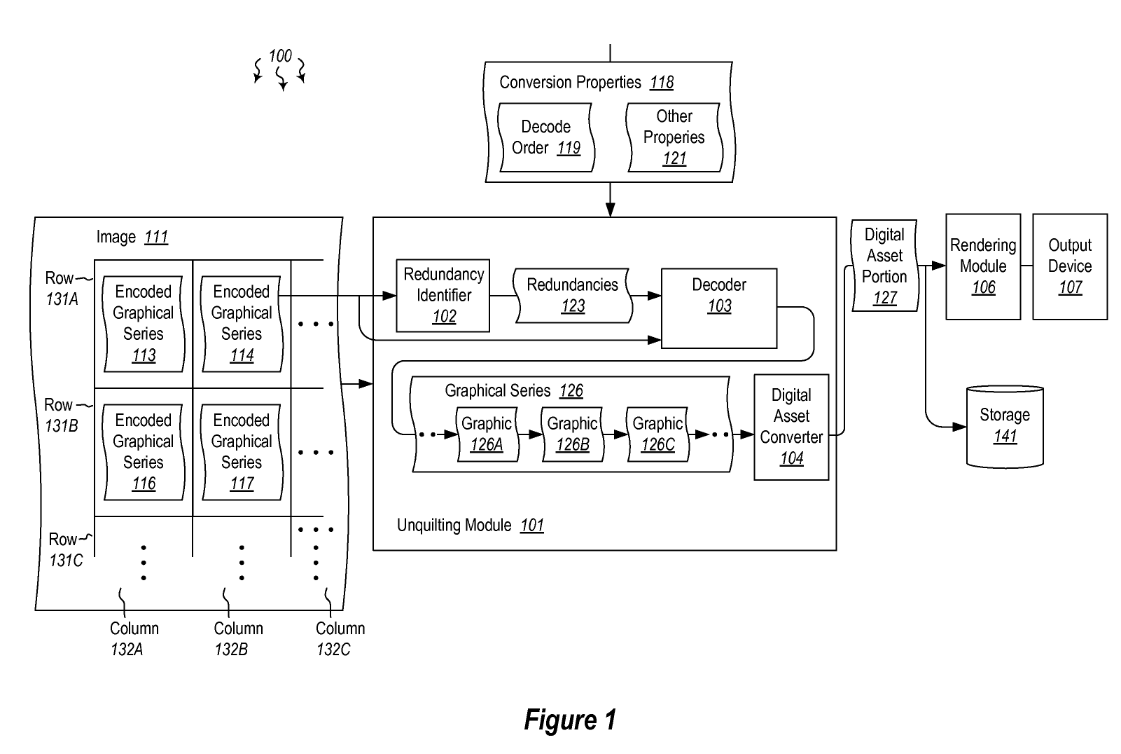

FIG. 1 illustrates an example computer architecture 100 that facilitates decoding a quilted graphic 2D image representation into a digital asset. Referring to FIG. 1, computer architecture 100 includes unquilting module 101, rendering module 106, output device 107, and storage 141. Unquilting module 101, rendering module 106, output device 107, and storage 141 can be connected to one another (or be part of) a network, such as, for example, a Local Area Network (“LAN”), a Wide Area Network (“WAN”), and even the Internet. Accordingly, quilting module 101, rendering module 106, output device 107, and storage 141 as well as any other connected computer systems and their components, can create message related data and exchange message related data (e.g., Internet Protocol (“IP”) datagrams and other higher layer protocols that utilize IP datagrams, such as, Transmission Control Protocol (“TCP”), File Transfer Protocol (“FTP”), Secure Copy Protocol (“SCP”), Hypertext Transfer Protocol (“HTTP”), Simple Mail Transfer Protocol (“SMTP”), etc.) over the network.

In general, unquilting module 101 is configured to unquilt one or more rows and one or more columns of a quilted graphic 2D image representation into a digital asset in accordance with conversion properties. A quilted graphic 2D image representation can include: sets of one or more one dimensional single image frames, two dimensional single image frames, a three dimension image set, a two dimensional image and/or Lidar set, a two dimensional image and/or point cloud set, a film strip set, a video quilt, single channel audio image, a stereo paired audio signal (e.g., right & left channel), an image quilt of multiple audio channels (i.e. surround sound 7.1 with seven channels), an image quilt of multiple songs in a single digital asset, and a larger set of images quilted together to form the largest image quilt. A digital asset can be virtually any type of digital object, including but not limited to: imagery data, audio data, video data, gaming data, broadcast data, radio data, digital book data, and geo-spatial data.

Conversion properties can include a decode order for decoding the one or more series of encoded graphic representations. Conversion properties can also include image properties for a two dimensional image, having one or more rows and one or more columns, that is to store at least a sub-set of the digital asset. The image properties can include a row size that indicates the size for any rows in the two dimensional image and including a column size that indicates the size for any columns in the two dimensional image. Conversion properties can also include other properties for the two dimensional image: levels of resolution in a hierarchical data structure within quilted graphic 2D image representation, data rate frequency (e.g., ranging from 2 Hz through 256 kHz), bit depth (e.g., ranging from 2 bit through 64 bit), an indication if bit depth is variable, a number of channels (e.g., ranging from 1 channel to multispectral or hyperspectral), processing type (e.g., discreet or non-discreet processing), data type (e.g., floating point or integer), scan type (e.g., interlaced or progressive), and encoding scheme (e.g., band interleaved by part/pixel (“BIP”), band interleaved by line (“BIL”), or band sequential (“BSQ”)).

As depicted, unquilting module 101 further includes redundancy identifier 102, decoder 103, and digital asset converter 104. Generally, encoded series of graphical representations can be stored taking redundancies into account such that that there is no need to retain complete graphic representations multiple times when the same visual or audio data is represented. Redundancy identifier 102 is configured to identify redundancies between successive graphic representations in an encoded series of graphic representations. For example, redundancy identifier 102 can identify portions of successive graphics representing the same visual data or audio data. Redundancy identifier 102 can arrange a data structure for decoding an encoded series of graphical representations into a series of graphical series that does retain complete graphic representations multiple times.

Decoder 103 is configured to decode an encoded series of graphic representations (e.g., from a row and column of a quilted graphic 2D image representation) into a decoded series of graphical representations. Decoder 103 takes into account identified redundancies so as to restore full graphic representations.

Digital asset converter 104 is configured to convert a series of graphic representations into a portion of a digital asset. For example, digital asset converter 104 can convert a series of graphic representations quilted into a quilted graphic 2D image representation into a set or sub-set of a digital asset (e.g., video frames, sound, game textures, imagery data, broadcast data, radio data, digital book data, or geospatial data).

Rendering module 106 is configured to render portions of digital assets at output device 107. Output device 107 can be, for example, a display device and/or audio output device. Storage device 141 is configured to store portions of digital assets.

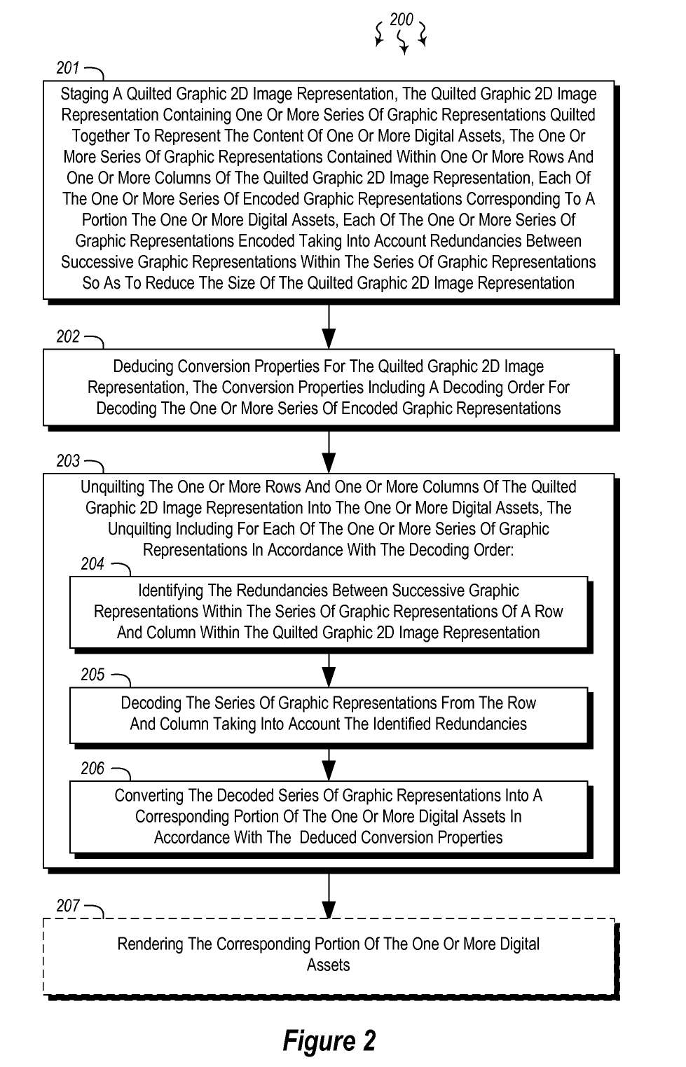

FIG. 2 illustrates a flow chart of an example method 200 for decoding a quilted graphic 2D image representation into a digital asset. Method 200 will be described with respect to the components and data of computer architecture 100.

Method 200 includes an act of staging a quilted graphic 2D image representation, the quilted graphic 2D image representation containing one or more series of graphic representations quilted together to represent the content of one or more digital assets, the one or more series of graphic representations contained within one or more rows and one or more columns of the quilted graphic 2D image representation, each of the one or more series of encoded graphic representations corresponding to a portion the one or more digital assets, each of the one or more series of graphic representations encoded taking into account redundancies between successive graphic representations within the series of graphic representations so as to reduce the size of the quilted graphic 2D image representation (act 201).

For example, computer system 100 can stage image 111. Image 111 can be a quilted graphic 2D image representation quilting together encoded graphical series in rows and columns to represent the content of one or more digital assets. For example, row 131A/column 132A stores encoded graphical series 113, row 131A/column 132B stores encoded graphical series 114, row 131B/column 132A stores encoded graphical series 116, row 131B/column 132B stores encoded graphical series 117. Other encode graphical series can be stored in other rows and columns, such as, for example, in row 131C, column 132C, etc.

One or more digital assets quilted into a quilted graphic 2D image representation can include one or more different types of data including but not limited to: imagery data, audio data, video data, gaming data, broadcast data, radio data, digital book data, and geo-spatial data. In some embodiments, a quilted graphic 2D image representation quilts together data of a single data type. In other embodiments, a quilted graphic 2D image representation quilts together data of a plurality of different data types. For example, a quilted graphic 2D image representation for a digital asset used by a navigation system can quilt together audio data, video data, and geo-spatial data.

Image 111 can include any of: sets of one or more one dimensional single image frames, two dimensional single image frames, a three dimensional image set, a two dimensional image and/or Lidar set, a two dimensional image and/or point cloud set, a film strip set, a video quilt, single channel audio image, a stereo paired audio signal (e.g., right & left channel), an image quilt of multiple audio channels (i.e. surround sound 7.1 with seven channels), an image quilt of multiple songs in a single digital asset (i.e., digital vinyl), a larger set of images quilted together to form the largest image quilt, etc.

To conserve computing resources, each of the encoded graphic representations in image 111 can be encoded taking into account redundancies between successive graphic representations within the encoded graphical series so as to reduce the size of image 111. During encoding, redundancies can be identified between portions of successive graphics representing the same visual and/or audio data such that there is no need retain the portions of successive graphics multiple times. For example, redundancies between successive graphic representations within encoded graphical series 113 can be utilized to reduce the size of encoded graphical series 113.

A series of graphic representations can also be encoded into a quilted graphic 2D image representation taking into account multiple levels of resolution within the series of graphic representations. For example, encoded graphical series 113 can be encoded into image 111 taking into account multiple levels of resolution within encoded graphical series 113.

Method 200 includes an act of deducing conversion properties for the quilted graphic 2D image representation, the conversion properties including a decoding order for decoding the one or more series of encoded graphic representations (act 202). For example, unquilting module 101 can deduce conversion properties 118, including decode order 119 and other properties 121. Decode order 119 indicates an order for decoding encoded graphical series 113, 114, 116, 117, etc. Other properties 121 can include image properties for image 111.

Method 200 includes an act of unquilting the one or more rows and one or more columns of the quilted graphic 2D image representation into the one or more digital assets (act 203). For example, unquilting module 101 can unquilt rows 131A-131C and columns 132A-132C into digital asset portion 127 as well as other additional digital asset portions. Each digital asset portion can be a portion of one or more of different types of data including but not limited to: imagery data, audio data, video data, gaming data, broadcast data, radio data, digital book data, and geo-spatial data. Upon accessing an encoded graphical image, unquilting module 101 can identify the source material digital asset as one or more of: imagery data, audio data, video data, gaming data, broadcast data, radio data, digital book data, or geo-spatial data.

For each of the one or more series of graphic representations in accordance with the decoding order, act 203 includes an act of identifying the redundancies between successive graphic representations within the series of graphic representations of a row and column within quilted graphic 2D image representation (act 204). For example, redundancy identifier 102 can access encoded graphical series 114. Redundancy identifier 102 can identify redundancies 123 between successive graphics of encoded graphical series 114. Redundancies 123 can identify portions of successive graphics representing the same visual and/or audio data such that at the time of encoding there was no need to retain the portions of successive graphics multiple times.

For each of the one or more series of graphic representations in accordance with the decoding order, act 203 includes an act of decoding the series of graphic representations from the row and column taking into account the identified redundancies (act 205). For example, decoder 103 can decode encoded graphical series 114 into graphical series 126. Decoder 103 can take into account redundancies 123 so as to restore full graphics 126A, 126B, 126C, etc.

Decoding can include identifying different embedded image resolutions within a quilted graphic 2D image representation, depending on transmission and viewing/listening capabilities desired during the decoding process. For example, decoder 103 can identify different image resolutions for encoded graphical series 114 within image 111. One of the different image resolutions can be selected, for example, depending on transmission and/or viewing/listening capabilities associated with output device 107. Decoder 103 can convert encoded series 114 into graphical series 126 at the selected image resolution.

For each of the one or more series of graphic representations in accordance with the decoding order, act 203 includes an act of converting the decoded series of graphic representations into a corresponding portion of the one or more digital assets in accordance with the deduced conversion properties (act 206). For example, digital asset converter 104 can convert graphical series 126 into digital asset portion 127 in accordance with conversion properties 118 (included a selected resolution).

Subsequently, method 200 can include an act of rendering the corresponding portion of the one or more digital assets at the computer system (act 207). For example, rendering module 106 can render digital asset portion 127 at output device 107 (e.g., a video and/or audio output device). Alternately and/or in combination, digital asset portion 127 can be stored at storage 141.

As described, decoding a series of graphic representations from a row and column of a quilted graphic 2D image representation can take into account the identified redundancies and levels of resolution contained within a quilted graphic 2D image representation. The quilted graphic 2D image representation is decoded into a string of values (imagery, audio, video, gaming, broadcast, digital book, radio, geo-spatial). For example, a quilted graphic 2D image representation is decoded into representation elements. The string of values can be computed from the image representation elements. The string of values is restored using any of variety of transfer functions. Once processed, the string of values is defined by an output format.

As appropriate, decoder 103 and/or digital asset converter 104 can adjust to account for different data types represented in image 111.

Also as appropriate, acts 204, 205, and 206 can be repeated for other encoded graphical series in image 111, such as, for example, encoded graphical series 113, 116, and 117. Thus, other portions of digital assets can be unquilted and decoded from image 111.

As such, in some embodiments, a computer system decodes a 2D graphic representation into one or more encoded graphic series (representing a digital asset) from rows/columns of the 2D graphic representation based on a decoding order. The computer system can account for redundancies, decode, and convert each encoded graphic series to a portion of a digital asset. The computer system can then render the portion of the digital asset.

Alternately, in other embodiments, a computer system decodes a plurality of smaller 2D graphic representations representing the content of a larger 2D graphic representation. The computer system converts the plurality of smaller 2D graphic representations into one or more encoded graphic series (representing a digital asset) from rows/columns of the smaller 2D graphic representations based on a decoding order. The computer system can account for redundancies, decode, and convert each encoded graphic series to a portion of a digital asset. The computer system can then render the portion of the digital asset.

During decoding and/or unquilting of a quilted graphic 2D image representations, original encoding conversion properties can be maintained/retained, including levels of resolution in a hierarchy data structure within a quilted graphic 2D image representation, data rate frequency (ranging from 2 Hz through 256 kHz), bit depth (ranging from 2 bit through 64 bit), variable bit depth, any number of channels from 1 channel to multispectral or hyperspectral, discreet or non-discreet processing, number of rows, number of columns, floating point or integer, interlaced or progressive, band interleaved by part/pixel (BIP), band interleaved by line (BIL), band sequential (BSQ).

A quilted graphic 2D image representation can be encoded to include multiple resolutions. Essentially any number of resolution levels can be used. For example, there may be 15 levels of resolution for a larger video file, or perhaps only 2 or 3 levels of resolution for a smaller audio file.

For video, different resolution levels can correspond to the format (e.g., of a movie) going from 1080p to 1080i to 720p etc. Each of these different resolution levels can be quilted into a quilted graphic 2D image representation together during encoding of video.

For audio, sample frequency is an approximate parallel. For example, a two dimensional image for a portion of audio may be 5000 pixel wide by 40000 pixel long or 200,000,000 pixels. Each pixel can be viewed as a sample. If the portion of audio was 7 minutes long, that would be 420 seconds. Thus, within a quilted graphic 2D image representation there is approximately 476,190.48 (200,000,000/420) samples per second of the portion of audio. As samples/second this can be represented by 476,190 Hz or roughly 476 KHz.

Practically, the highest “resolution” detail can represent 128 KHz. From there, lower and lower “resolutions” 64 KHz, 32 KHz, etc., down to 2 Hz. In other environments, 44.1 KHz may be the highest resolution and then the next lower resolution which is 22.05 KHz. Each of these different resolution levels can be quilted into a quilted graphic 2D image representation together during encoding of the portion of audio.

Devices can request that a quilted graphic 2D image representation supply digital asset data (audio, video, etc.) at a specified resolution that is at or below the highest resolution quilted into the quilted graphic 2D image representation. 15 resolution states may be quilted into a quilted graphic 2D image representation a digital asset of video data. 15 is the highest resolution (e.g., full 4K) and 1 is the lowest resolution. A device with a lower screen resolution (e.g., a mobile phone or tablet) can “ask the file” to supply it with a resolution state of “5” out of “15”. A device with higher screen resolution (e.g., a workstation editing machine) can request resolution state “15”.

Similarly, 3 resolution states may be quilted into a quilted graphic 2D image representation representing a digital asset of audio data. 3 is the highest resolution (e.g., 96 KHz) and 1 is the lowest resolution (e.g., 22.05 KHz). A device attached to a limited bandwidth network might not want to stream an audio data at a full resolution of “3”. Instead, the device can request a lower resolution, possibly “1”.

By taking redundancies between successive graphic image representations into account, embodiments of the invention can reduce resource consumption when storing digital assets in quilted graphic 2D image representations. A digital asset can be recreated at a desired resolution by unquilting a quilted graphic 2D image representation (or portion there). Thus, a digital asset can be stored in a format that conserves computing resources and the digital asset remains available for rendering at a variety of different resolutions from a single source quilted graphic 2D image representation.

For example, a resulting lossless quilted graphic 2D image representation of raw audio data can consume approximately ⅛^{th} the resources as the raw audio data itself. As such, the two dimensional image can be unquilted to access the raw audio data during play back. Lossy reductions can facilitate even more significant resource savings. For example, a lossy quilted graphic 2D image representation of raw video data (e.g., a movie) can consume approximately 1/200^{th} the resources as the raw video data itself. As such, the two dimensional image can be unquilted to access an approximation of the raw video data during play back.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed:

1. At a computer system including one or more processors and system memory, a computer-implemented method for decoding a quilted graphic 2D image representation into digital assets, the method comprising:
an act of staging a quilted graphic 2D image representation, the quilted graphic 2D image representation containing one or more series of graphic representations quilted together to represent the content of one or more digital assets, the one or more series of graphic representations contained within one or more rows and one or more columns of the quilted graphic 2D image representation, each of the one or more series of encoded graphic representations corresponding to a portion the one or more digital assets, each of the one or more series of graphic representations encoded taking into account redundancies between successive graphic representations within the series of graphic representations so as to reduce the size of the quilted graphic 2D image representation;
an act of deducing conversion properties for the quilted graphic 2D image representation, the conversion properties including a decoding order for decoding the one or more series of encoded graphic representations; and
an act of unquilting the one or more rows and one or more columns of the quilted graphic 2D image representation into the one or more digital assets, the unquilting including for each of the one or more series of graphic representations in accordance with the decoding order:
an act of identifying the redundancies between successive graphic representations within the series of graphic representations of a row and column within the quilted graphic 2D image representation;
an act of decoding the series of graphic representations from the row and column taking into account the identified redundancies; and
an act of converting the decoded series of graphic representations into a corresponding portion of the one or more digital assets in accordance with the deduced conversion properties.

2. The method as recited in claim 1, further comprising for each of the one or series of graphic representations subsequent to converting the decoded series of graphic representations into a corresponding portion of the one or more digital assets, an act of rendering the corresponding portion of the one or more digital assets at the computer system.

3. The method as recited in claim 3, wherein the act of rendering the corresponding portion of the one or more digital assets at the computer system comprises an act of rendering the corresponding portion of the one or more digital assets at one of: a mobile phone and a tablet device.

4. The method as recited in claim 1, wherein the act of staging a quilted graphic 2D image representation comprises an act of staging a quilted graphic 2D image representation that includes one or more of: imagery data, audio data, video data, gaming data, broadcast data, radio data, digital book data, and geo-spatial data.

5. The method as recited in claim 1, wherein the act of staging a quilted graphic 2D image representation comprises an act of staging a quilted graphic 2D image representation that includes one of: sets of one or more one dimensional single image frames, two dimensional single image frames, a three dimensional image set, a two dimensional image and/or Lidar set, a two dimensional image and/or point cloud set, or a film strip set.

6. The method as recited in claim 1, wherein staging a quilted graphic 2D image representation comprises an act of staging a quilted graphic 2D image representation that has multiple levels of resolution for the one or more digital assets embedded within the quilted graphic 2D image representation.

7. The method as recited in claim 6, wherein act of deducing conversion properties for the quilted graphic 2D image representation comprises an act of deducing one or more of: a resolution for the one or more digital assets, the resolution from among the multiple levels of resolution embedded within the quilted graphic 2D image representation, a data rate frequency for the quilted graphic 2D image representation, a bit depth for the quilted graphic 2D image representation, a number of channels for the quilted graphic 2D image representation, processing type for the quilted graphic 2D image representation, scan type for the quilted graphic 2D image representation, and encoding scheme for the quilted graphic 2D image representation.

8. The method as recited in claim 7, wherein unquilting the one or more rows and one or more columns of the quilted graphic 2D image representation comprises unquilting the one or more rows and one or more columns of the quilted graphic 2D image representation taking into account the deduced resolution for the one or more digital assets.

9. The method as recited in claim 1, wherein the act of unquilting the one or more rows and one or more columns of the quilted graphic 2D image representation into the one or more digital assets comprises an act of unquilting a video quilt into video data.

10. The method as recited in claim 1, wherein the act of unquilting the one or more rows and one or more columns of the quilted graphic 2D image representation into the one or more digital assets comprises an act of unquilting one of: a single channel audio image, an image quilt of a stereo paired audio signal, or an image quilt of three of more audio channels into audio data.

11. The method as recited in claim 1, wherein an act of converting the decoded series of graphic representations into a corresponding portion of the one or more digital assets comprises an act of converting a series of graphic representations into one or more of: video frames, sound, game textures, and geospatial data.

12. A computer program product for use at a computer system, the computer program product for implementing a method for decoding a quilted graphic 2D image representation into digital assets, the computer program product comprising one or more computer storage devices having stored thereon computer-executable instructions that, when executed at a processor, cause the computer system to perform the method, including the following:
stage a quilted graphic 2D image representation, the quilted graphic 2D image representation containing one or more series of graphic representations quilted together to represent the content of one or more digital assets, the one or more series of graphic representations contained within one or more rows and one or more columns of the quilted graphic 2D image representation, each of the one or more series of encoded graphic representations corresponding to a portion the one or more digital assets, each of the one or more series of graphic representations encoded taking into account redundancies between successive graphic representations within the series of graphic representations so as to reduce the size of the quilted graphic 2D image representation;
deduce conversion properties for the quilted graphic 2D image representation, the conversion properties including a decoding order for decoding the one or more series of encoded graphic representations; and
unquilt the one or more rows and one or more columns of the quilted graphic 2D image representation into the one or more digital assets, the unquilting including for each of the one or more series of graphic representations in accordance with the decoding order:
identify the redundancies between successive graphic representations within the series of graphic representations of a row and column within the quilted graphic 2D image representation;
decode the series of graphic representations from the row and column taking into account the identified redundancies; and
convert the decoded series of graphic representations into a corresponding portion of the one or more digital assets in accordance with the deduced conversion properties.

13. The computer program product as recited in claim 12, further comprising computer-executable instructions that, when executed, cause the computer system to rendering the corresponding portion of the one or more digital assets at the computer system.

14. The computer program product as recited in claim 12, wherein computer-executable instructions that, when executed, cause the computer system to stage a a quilted graphic 2D image representation comprise computer-executable instructions that, when executed, cause the computer system to stage a quilted graphic 2D image representation that includes one or more of: imagery data, audio data, video data, gaming data, broadcast data, radio data, digital book data, and geo-spatial data.

15. The computer program product as recited in claim 12, wherein computer-executable instructions that, when executed, cause the computer system to stage a a quilted graphic 2D image representation comprise computer-executable instructions that, when executed, cause the computer system to stage a quilted graphic 2D image representation that has multiple levels of resolution for the one or more digital assets embedded within the quilted graphic 2D image representation.

16. The computer program product as recited in claim 15, wherein computer-executable instructions that, when executed, cause the computer system to unquilt the one or more rows and one or more columns of the quilted graphic 2D image representation comprise computer-executable instructions that, when executed, cause the computer system to unquilt the one or more rows and one or more columns of the quilted graphic 2D image representation taking into account a selected resolution for the one or more digital assets, the selected resolution selected from among the multiple levels of resolution embedded within the quilted graphic 2D image representation.

17. The computer program product as recited in claim 15, wherein computer-executable instructions that, when executed, cause the computer system to unquilt the one or more rows and one or more columns of the quilted graphic 2D image representation comprise computer-executable instructions that, when executed, cause the computer system to unquilt a video quilt into video data.

18. The computer program product as recited in claim 15, wherein computer-executable instructions that, when executed, cause the computer system to unquilt the one or more rows and one or more columns of the quilted graphic 2D image representation comprise computer-executable instructions that, when executed, cause the computer system to unquilt one of: a single channel audio image, an image quilt of a stereo paired audio signal, or an image quilt of three of more audio channels into audio data.

19. A computer system, the computer system comprising:
one or more processors;
system memory;
one or more computer-readable storage devices having stored there one computer-executable instructions representing an unquilting module, the unquilting module configured to:
access a staged quilted graphic 2D image representation, the quilted graphic 2D image representation containing one or more series of graphic representations quilted together to represent the content of one or more digital assets, the one or more series of graphic representations contained within one or more rows and one or more columns of the quilted graphic 2D image representation, each of the one or more series of encoded graphic representations corresponding to a portion the one or more digital assets, each of the one or more series of graphic representations encoded taking into account redundancies between successive graphic representations within the series of graphic representations so as to reduce the size of the quilted graphic 2D image representation;
deduce conversion properties for the quilted graphic 2D image representation, the conversion properties including a decoding order for decoding the one or more series of encoded graphic representations; and
unquilt the one or more rows and one or more columns of the quilted graphic 2D image representation into the one or more digital assets, the unquilting including for each of the one or more series of graphic representations in accordance with the decoding order:
identify the redundancies between successive graphic representations within the series of graphic representations of a row and column within the quilted graphic 2D image representation;
decode the series of graphic representations from the row and column taking into account the identified redundancies; and
convert the decoded series of graphic representations into a corresponding portion of the one or more digital assets in accordance with the deduced conversion properties.

20. The computer system as recited in claim 19, wherein the computer system comprises one of: a mobile telephone or a tablet.
